(19) United States
(12) Patent Application Publication
(10) Pub. No.: US 2026/0176464 A1
(43) Pub. Date: Jun. 25, 2026

(54) A BIOPOLYMER ADHESIVE SYSTEM AND A METHOD OF SEPARATELY APPLYING PARTS OF THE BIOPOLYMER ADHESIVE SYSTEM

(71) Applicant: Stora Enso OYJ, Helsinki (FI)

(72) Inventors: YOUSEF NASLI BAKIR, Saltsjö-boo (SE); Benyahia Nasli Bakir, Stockholm (SE)

(73) Assignee: STORA ENSO OYJ, Heisinki (FI)

(21) Appl. No.: 19/125,918

(22) PCT Filed: Oct. 11, 2023
(86) PCT No.: PCT/SE2023/051017

§ 371 Date: Apr. 30, 2025

(30) Foreign Application Priority Data
Nov. 1, 2022 (SE) 2230349-9

(51) Int. Cl. C08L 63/00; C08F 220/06

(52) U.S. Cl. CPC C08L 63/00; C08F 220/06

(57) ABSTRACT

The present invention relates to a biopolymer adhesive system where its parts contain bio-based components and a method of separately applying said parts of the biopolymer adhesive system, wherein the viscosity and distance between the parts are specified to certain parameters when applying onto substrate and usage thereof.

### FIELD OF THE INVENTION

The present invention relates to a biopolymer adhesive system and a kit comprising at least one biopolymer part and at least one bio-crosslinker part and a method of separately applying the parts.

### BACKGROUND

When it comes to adhesives the key developments in adhesive technologies used in wood will continue to be driven by cost and tightening regulations and reducing Volatile Organic Compounds (VOC) emissions and carbon footprint. Big drivers are cost-efficient production of wood products with faster curing adhesives, lower consumption of resins, and the demand for cheaper, bio-based raw materials and reduction of energy consumption. With increasing cost of fossil based raw material and growing environmental concerns, biobased adhesives are being developed using lignin, tannin, pyrolysis oil and other carbohydrates. Due to the health hazard of formaldehyde and stricter legislation on formaldehyde emissions, research is conducted to produce formaldehyde-free resins using synthetic or bio-based raw materials and this has shown results at least as good as fossil based adhesives in bonding strength, but also lowering carbon footprint and VOC emissions. What has so far limited the use of bio adhesives as a major player in the wood adhesive market is the total cost of bio adhesives per m2 or m3 for production of wood construction. The total cost of all wood adhesives is directly affected by, but not limited to, the adhesive amount needed per m2 or m3 for production of wood constructions, adhesive waste, pressing times/productivity and energy consumption/pressing temperature you need to harden the adhesive. Usually, biobased adhesives have a higher raw material cost in comparison to fossil based wood adhesives. When raw material costs are high, the next course of action is to find different solutions in order to lower the total cost of the adhesive system. One of the most prominently used solutions when it comes to lowering the total costs for fossil based adhesives is separately applying the polymer part from the crosslinker part when applying onto a substrate, which can be found in SE1730281 A1 and WO99/67028.

When it comes to biopolymer adhesive systems, separate application has not been feasible due to difficulties with compatibility, mixability and dispersibility when separately applying the biopolymer part from the bio-crosslinker part onto a substrate. One of the most prominently used biopolymer parts in wood adhesives are lignin and/or tannins. However, biopolymer adhesives based on lignin and/or tannins in aqueous solutions, which are hydrophilic, face difficulties when separately applying the bio-crosslinker part, which is hydrophobic, and the biopolymer part onto a substrate. Consequently, current methods rely on mixing the two parts before applying the adhesive system onto a substrate, examples of such methods can be found in WO2020008311 A1, WO2021124127 A1, SE544555C2 and WO2020230034. With these methods the biopolymer part in the adhesive system is already mixed with the cross-linker part before applying onto a substrate and the mix is therefore not useable for long periods.

Mixing a biopolymer part with a bio-crosslinker part prior to their application onto a substrate poses several challenges. Upon mixing, these parts initiate a reaction that causes the mixture to thicken and harden. As a result, there is a heightened risk of the adhesive prematurely solidifying within dispensing equipment.

To counteract precuring, the reactivity of both parts is intentionally reduced. However, this compromise leads to some unfavourable outcomes. A reduced reactivity typically results in extended production times and may in some contexts lead to compromised bonding strength. One major contributor to the longer production time is the extended pressing time required; that is, the duration for which the substrates need to be held together post-application of the adhesive to ensure adequate bonding. The diminished bonding strength means that users, such as wood construction manufacturers, find themselves using a larger quantity of the adhesive mixture than would ideally be necessary. This not only increases material costs but also has potential implications for structural integrity.

In addition to the rapid setting issue, mixing adhesive components before application introduces other notable challenges. The uniformity of the mixture is crucial; any inconsistencies can lead to variations in the adhesive's performance across different sections of the substrate. This variability can be problematic in applications demanding consistent bonding strength. Furthermore, the shelf life of pre-mixed adhesive is reduced, given that the reactive components have already been combined, leading to concerns about the product's stability over time. There are also challenges in relation to storage conditions; mixed adhesives often require specific temperature and humidity conditions to prevent degradation or changes in viscosity. Furthermore, for manufacturers, the need to ensure thorough mixing and prevent sedimentation or phase separation in the mixture can necessitate additional equipment or protocols, complicating the production process and introducing potential points of failure.

### SUMMARY OF THE INVENTION

The present invention solves the aforementioned problems by enabling for a biopolymer part and a bio-crosslinker part to be applied separately while both parts are in aqueous form.

These and other objects are fulfilled by the present invention as defined by the independent claims. Preferred embodiments are defined by the dependent claims.

In a first aspect of the present invention there is proposed a method of applying a biopolymer adhesive system, comprising applying in any order:
i) at least one biopolymer part comprising at least one biopolymer component in aqueous solution form, wherein said biopolymer component is selected from a group consisting of: tannin, lignin, starch and other carbohydrate, or a mixture thereof;
ii) at least one bio-crosslinker part comprising at least one bio-crosslinker component in aqueous solution form, wherein the bio-crosslinker component is selected from a group consisting of one or more of glycidyl ether type;
   wherein the viscosity of one part, or both parts is maximum 6000 mPas, preferably maximum 3000 mPas, most preferred maximum 1500 mPas measured with viscosimeter Brookfield LVT, temperature 25° C., spindle 4, 60 rpm. The parts are applied separately onto at least one substrate with a distance of less than 5 mm between biopolymer part and bio-crosslinker part.

The two parts may be applied either as a strand or by means of spraying, rolling, curtain coating, or through a unit comprising at least two hollow members, with a dedicated member for each part, or any combination of the aforementioned methods, applied in any sequence.

In a second aspect of the present invention there is proposed a biopolymer adhesive system obtainable by the first aspect of the present invention.

In a third aspect of the present invention there is proposed a use of a biopolymer adhesive system according to the second aspect of the present invention.

In a fourth aspect of the present invention there is proposed a kit. The proposed kit comprises a biopolymer part and a bio-crosslinker part, both in aqueous solution form. The biopolymer part comprises at least one biopolymer component selected from a group consisting of: tannin, lignin, starch and other carbohydrate, or a mixture thereof. The bio-crosslinker part comprises at least one biopolymer component selected from a group of one or more of glycidyl ether type. The kit further comprises instructions which recite that the biopolymer part and bio-crosslinker are to be applied separately.

Further objects and advantages of the present invention will be discussed below by means of exemplifying embodiments.

### FIGURES

FIG. 1 illustrates one aspect of the present invention.

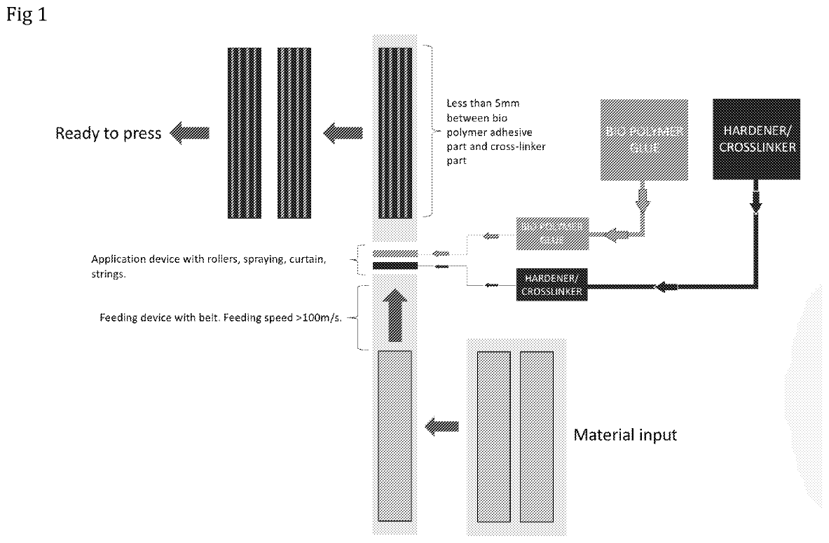

### DEFINITIONS

The expressions “bio-crosslinker” or “hardener” may be used interchangeably in the present specification and would have the same meaning. This also pertains the expressions “fiber” or fibre”, and also the expressions “adhesive” or “glue” mutatis mutandis.

A “wood adhesive” is any substance applied to the surfaces of materials that binds them together and resists separation. A wood adhesive is used to bond wood components such as veneers, strands, particles, fibres, lumber etc. Wood is bonded for both exterior and interior applications and used in the assembly of furniture and cabinets, manufacture of composite wood products, and construction of residential and commercial structures. Important factors and parameters influencing the wood bonding are type of resin used, adhesive amount, wood species, pressing time and pressing temperature.

In the context of the present invention, the term “bio-crosslinker” refers to a crosslinker that is derived from biological sources or biobased materials. This distinction emphasizes that the crosslinker is not merely any conventional crosslinker, but rather one that is sourced from renewable and sustainable biological origins. Such biobased materials can include, but are not limited to, plants, microorganisms, or animal-derived materials. The utilization of a bio-crosslinker underlines the environmentally-conscious approach of the invention, seeking to reduce dependence on petroleum-based products and promote sustainability.

### DETAILED DESCRIPTION OF THE INVENTION

The present invention is based on the surprising insight that an adhesive system comprising a biopolymer part in aqueous form, and a bio-crosslinker part in aqueous form may be applied separately if at least one of said parts exhibits a certain viscosity. This discovery is particularly remarkable considering the inherent characteristics of the components: the biopolymer part being hydrophilic and the bio-crosslinker being lipophilic (hydrophobic). Usually, hydrophilic substances are attracted to water and repel oils, while lipophilic (hydrophobic) substances are attracted to oils and repel water, leading to inherent challenges in achieving a homogeneous mixture between the two.

When separately applying the biopolymer part and the bio-crosslinker part the total cost of adhesive per m2 or m3 of wood constructions are significantly reduced. Furthermore the waste of the biopolymer adhesive system is also significantly reduced. This is achieved by the two parts being separate from each other, which means the biopolymer adhesive will not thicken or harden before pressure/pressing is applied and stay usable in the machines for a long period of time. This results in that the production of wood constructions can easily be paused and continued the next day without the leftover biopolymer part or the bio-cross-linker part in the machines having to be thrown away.

Separately applying the biopolymer part and the bio-cross-linker part will also result in a reduced amount of adhesive used. In contrary, by mixing biopolymer part and bio-cross-linker part prior to being applied onto substrate, you run the risk of the adhesive thickening or hardening too quickly in the machines. To prevent this, wood construction producers generally use a higher amount of the said mixed parts than necessary.

The present invention solves the aforementioned problems by enabling for a biopolymer part and a bio-crosslinker part to be applied separately while both parts are in aqueous form. This is achieved by adapting the viscosity of at least one of the parts in relation to the distance at which these two parts are applied. This enables for the proposed adhesive system to use much less adhesive per m2, because you never run the risk of the adhesive thickening or hardening before pressing. Furthermore, by separately applying the biopolymer part and the bio-crosslinker part, you can greatly shorten press times and increase productivity by catalysing and making biopolymer part more reactive to the bio-crosslinker part without having to think about the use time/pot life of the adhesive system. The reactivity of the biopolymer part to the bio-crosslinker part may be increased by for example increasing the pH, using a catalyst and/or accelerator. Separate application of parts of a biopolymer adhesive system offers increased flexibility in the gluing process and will result in an easier and quicker market implementation of biopolymer adhesives as well as reduce harmful fossil based adhesives on the market. Further, the drawbacks previously mentioned above for adhesives emitting VOC would be avoided.

Separate application greatly reduces the cost of all other aspects, outside of the raw material cost, that contribute to the total cost of the adhesive and therefore making biopolymer adhesive more attractive on the market. For example, separate application also reduces energy consumption and results in reduced washing liquid consumption during and/or after the gluing process. In a first aspect of the present invention there is proposed a method of applying a biopolymer adhesive system, comprising applying in any order:
i) at least one biopolymer part comprising at least one biopolymer component in aqueous solution form, wherein said biopolymer component is selected from a group consisting of: tannin, lignin, starch and other carbohydrate, or a mixture thereof;
ii) at least one bio-crosslinker part comprising at least one bio-crosslinker component in aqueous solution form, wherein the bio-crosslinker component is selected from a group consisting of one or more of glycidyl ether type;
   wherein the viscosity of one part, or both parts is maximum 6000 mPas, preferably maximum 3000 mPas, most preferred maximum 1500 mPas measured with viscosimeter Brookfield LVT, temperature 25° C., spindle 4, 60 rpm. The parts are applied separately onto at least one substrate with a distance of less than 5 mm between biopolymer part and bio-crosslinker part. The two parts may be applied either as a strand or by means of spraying, rolling, curtain coating, or through a unit comprising at least two hollow members, with a dedicated member for each part, or any combination of the aforementioned methods, applied in any sequence.

According to one embodiment of the first aspect the bio-crosslinker part is selected from a group consisting of: glycerol diglycidyl ether, glycerol glycidylether, polyglycerol diglycidyl ether, polyglycerol polyglycidyl ether, glycerol triglycidyl ether, trimethylolpropane diglycidyl ether, polyoxypropylene glycol diglycidylether, polyoxypropylene glycol triglycidyl ether, diglycidylether of cyclohexane dimethanol, sorbitol polyglycidyl ether, alkoxylated glycerol polyglycidyl ether, trimethylolpropane triglycidyl ether, resorcinol diglycidyl ether, isosorbide diglycidyl ether, pentaerythritol tetraglycidyl ether, ethylene glycol diglycidyl ether, polyethylene glycol diglycidyl ether having 2-9 ethylene glycol units, propylene glycol diglycidyl ether having 1-5 propylene glycol units, diglycidyl ether of terminal diol having a linear carbon chain of 3-6 carbon atoms, preferably biobased, and mixtures thereof.

According to a preferred embodiment of the first aspect the bio-crosslinker part is selected from a group consisting of: glycerol diglycidylether, glycerol glycidylether, glycerol polyglycidylether and polyglycerol polyglycidyl ether.

According to another preferred embodiment of the first aspect said biopolymer part comprises lignin. In the proposed embodiment the lignin is selected from a group consisting of: Kraft lignin, lignosulfonate, organosolv lignin, soda lignin or lignin extracted from sugar cane bagasse, or a lignin isolated from black liquor, or mixture thereof, preferably kraft or bagasse lignin. Optionally, the lignin has been further purified and optionally modified by glyoxylation, etherification or esterification. Tannin is optionally modified to hydrolyzable and/or condensed tannins, or to pyrogallol type tannins and catechol type (or catechin type) tannins, or pure or chemical modifications of the Black Wattle bark extract, optionally modified by glyoxalation, etherification or esterification.

According to a preferred embodiment of the first aspect the surface tension altering agent is selected from the group comprising: surfactants, emulsifiers, nonionic surfactants, solvent or tensides, such as ethoxylates, alkoxylates, and cocamides, and/or polyisobutylene succinic anhydride (PIBSA) based surfactant, polypropylene glycol (PPG), paraffinic compounds or a combination thereof, preferably a non-ionic surfactant or PIBSA-based surfactant or a combination thereof, most preferred biobased. Non-limiting examples of surface tension altering agents are: Ethylan 1005 (2-propyl-heptanol-etoxilate), Berol 360 (C10—alcohol-etoxilate), Perlastan (L-glutamic acid, N-cocosacylderivate di-sodium-salt) and polypropylene glycol. It is known that surfactant is used to improve the wetting of the substrate. However, in the present case the surface tension altering agent is used for wetting the substrate but also to increase the miscibility between the components, especially when using low amounts of bio-crosslinker part and/or a low amount of biopolymer part.

According to a preferred embodiment of the first aspect the parts are applied separately onto the at least one substrate, less than 5 mm between biopolymer part and bio-crosslinker part, preferably less than 3 mm, most preferred less than 2 mm, in the form a strand, ribbon, or by spraying or by roller or by curtain or unit of at least two hollow members, at least one member for each component or any combination thereof in any order.

In one embodiment of the first aspect of the present invention the biopolymer part and the bio-crosslinker part are applied with a distance of 0-5 mm apart, and the viscosity of either the biopolymer part, the bio-crosslinker part, or both parts, is from 50 to 1500 mPas; or the parts are applied with a distance of 0-3 mm apart and the viscosity of either or both parts is from 1500 to 3000 mPas; or the parts are applied with a distance of 0-2 mm apart and the viscosity of either or both parts is from 3000 to 6000 mPas.

The combination of viscosity and proximity between the biopolymer part and the bio-crosslinker part is key to the application's efficiency. When the parts are applied closely, specifically within a distance of less than 5 mm, it facilitates reduced adhesive consumption due to the parts' proximity. Distances of less than 3 mm or even less than 2 mm are even more beneficial. Such short distances foster enhanced miscibility, mixability, compatibility, and dispersibility between the parts, ensuring that the parts of the biopolymer adhesive system interact optimally.

By optimizing this proximity, the parts of the biopolymer adhesive system can react more effectively, establishing a robust and swift bond with the substrate. Furthermore, closer application distances allow for the utilization of reduced time required during pressing, i.e., the time at which substrates are pressed together after the application of adhesive/glue. This is particularly advantageous for applications or manufacturing processes that operate at lower pressing time.

However, maintaining a short distance, such as 5 mm, between the parts can offer its own set of advantages. A controlled gap might provide a short window of flexibility post-application for potential repositioning or adjustments before the final curing. This is particularly beneficial in scenarios where precise alignment is paramount. Additionally, each part can achieve its optimal penetration or absorption rate into the substrate before interaction with the other, leading to a potentially more uniform bond. Lastly, in cases where the substrate or the parts possess intricate layers or structures, a short separation ensures these configurations are undisturbed by the immediate interaction of the components, preserving layer integrity.

A desired viscosity is achieved by adjusting the dry content of the biopolymer part, which can be increased or decreased. This adjustment can be effected by the addition of components such as additives, diluents, thickeners, among others.

For the bio-crosslinker part, a desired viscosity can be attained by the incorporation of diluents, thickeners, or a combination of one or more high-viscosity bio-crosslinkers and one or more low-viscosity bio-crosslinkers. The viscosity is preferably determined using a Brookfield LVT instrument, with Spindle 4 at a rotation speed of 60 rpm and a temperature of 25° C. The present invention proposes a number of different sequences for applying the biopolymer part and the bio-crosslinker part. Whether method is chosen depends on the desired properties of the resulting product or on what method of production is suitable within the specific context in which the biopolymer adhesive system is used.

For example, in one proposed embodiment the biopolymer part is applied before the bio-crosslinker part is applied. This has the beneficial effect of ensuring a more uniform and stable layer of the biopolymer on the substrate. By establishing this layer first, it can provide an optimal matrix for the bio-crosslinker to interact, leading to more consistent and effective crosslinking reactions. This can result in a more durable and resilient final product.

However, in another proposed embodiment the bio-crosslinker part is applied before the biopolymer part. This has the beneficial effect of priming the substrate with reactive sites. When the biopolymer part is subsequently applied, it can rapidly bind to these primed sites, potentially speeding up the reaction or curing time. This approach may also enhance the bond strength between the substrate and the biopolymer part, providing better adhesion and longevity.

Within the scope of the present invention there is also proposed mixed sequences, in which the parts are divided into portions and applied in a specific order. For example, according to one embodiment a portion of the biopolymer part is applied before the bio-crosslinker part is applied and another portion of the biopolymer part is applied after the bio-crosslinker part is applied. This has the beneficial effect of creating a layered structure. The initial layer of biopolymer ensures that there's an adequate matrix for the bio-crosslinker to interact with. Once the bio-crosslinker is applied and begins its crosslinking process, the subsequent application of the biopolymer can encapsulate the bio-crosslinker, potentially providing enhanced stability, controlled release, or a protective barrier against environmental factors, leading to a composite material with diverse properties.

According to another embodiment a portion of the bio-crosslinker part is applied before the biopolymer part is applied and another portion of the bio-crosslinker part is applied after the biopolymer part is applied. This has the beneficial effect of ensuring that the substrate is initially primed with reactive sites from the bio-crosslinker. The biopolymer, when applied, can rapidly bind to these primed sites. The subsequent application of the bio-crosslinker on top can ensure that any exposed or unreacted portions of the biopolymer part are further crosslinked, leading to a more thorough and homogeneous crosslinking process. This approach can provide a final product with increased cohesive strength and potentially faster curing times.

The proposed biopolymer adhesive system may not comprise any additives. In other examples the biopolymer adhesive system may comprise one or more additives. Additives may be added to either or both biopolymer part and bio-crosslinker part, or individually in the biopolymer adhesive system. However additives may also be applied separately as primer onto substrate before or after the biopolymer adhesive system parts are applied. In one proposed embodiment the biopolymer adhesive system comprises at least one additive selected from a group consisting of: chalk, urea, kaolin, gelatine, soy protein, tackifier, surfactant, emulsifier, glycerol, chitin, pectin, dextrose, wheat flour, wheat gluten, polyvinyl acetate dispersion, ethylene vinyl acetate dispersion, SBR (styrene butadiene rubber), amines, polyvinyl alcohol, glycols, polyethylene glycol, polypropylene glycols, diglycerol, butanediol, sorbitol, alkyl citrates, dimethyl sulfoxide, polyethers, sugars, alcohol ethers, silane, silicate, cellulose, carbamide peroxide, dihydrogen dioxide, hydrogen dioxide, urea hydrogen peroxide, urea peroxide, peroxide, polyglycerol, hydroxymethylfurfural, furfural, furfural alcohol, solvents, dispersing agent, plasticizer, formaldehyde-donating agent, propylene carbonate, ethylene carbonate, acetoxymethyl furfural, ethylene carbonate, glycols, ethylene glycol, triacetin, limestone, sodium carbonate, sodium dodecylbenzenesulfonate (2-dodecen-1-yl), succinic anhydride, sodium dodecyl sulfonate, peroxide, expancel, hydrophobizing agent, waxes, ethylene urea, hollow glass spheres, preservatives, Melamine, Melamine resin, organic carbonates, calcium hydroxide, potassium acetate, sodium acetate, sodium formate, glyoxal, mineral salts, organic salts, bases or a mixture thereof.

The present invention allows for a wide range of weight ratio between the biopolymer part and the bio-crosslinker when applying said parts. The specific weight ratio desired depends to the desired properties of the end product as well as what method of manufacturing is suitable in the specific context. For example, in furniture manufacturing, a certain weight ratio might be preferred to ensure a strong bond, whereas in floor installations or cabinetry production, a different weight ratio could be chosen for optimized flexibility and durability.

According to a preferred embodiment of the first aspect, the weight ratio of biopolymer part to bio-crosslinker part ranges from 100:5 to 10:100 wt %. This broad range offers flexibility in tuning the properties of the resulting composite material. At higher biopolymer concentrations (e.g., 100:5 wt %), the beneficial effect is likely to be a material with enhanced mechanical properties, elasticity, and flexibility, as the dominant biopolymer part provides a continuous phase. The small amount of bio-crosslinker helps in providing minimal cross-linking, ensuring the biopolymer retains most of its inherent properties. Furthermore, a smaller amount of bio-crosslinker is advantageous as there is potential for cost saving since a bio-crosslinker component is generally more expensive than a biopolymer component.

In the preferable weight ratio of from 100:30 to 50:100 wt %, a more balanced interaction between the biopolymer and the bio-crosslinker is achieved. This results in the beneficial effect of a material that combines the properties of both components. The structure is likely to exhibit balanced mechanical strength, resilience, and potentially controlled degradation or release rates, making it suitable for applications where both elasticity and durability are essential.

In the most preferred weight ratio of from 100:50 to 100:100 wt %, the resulting material is expected to have enhanced cross-linking, leading to the beneficial effect of a robust, durable, and highly interconnected structure. With equal parts of biopolymer and bio-crosslinker, the system can optimize cross-linking density, providing a matrix that resists external stresses, chemicals, or degradation. This might be ideal for applications where structural integrity and longevity are paramount.

In a second aspect of the present invention there is proposed a biopolymer adhesive system obtainable by the first aspect of the present invention, or by aforementioned embodiments thereof.

In a third aspect of the present invention there is proposed a use of a biopolymer adhesive system according to the second aspect of the present invention.

In a fourth aspect of the present invention there is proposed a kit. The proposed kit comprises a biopolymer part and a bio-crosslinker part, both in aqueous solution form. The biopolymer part comprises at least one biopolymer component selected from a group consisting of: tannin, lignin, starch and other carbohydrate, or a mixture thereof. The bio-crosslinker part comprises at least one biopolymer component selected from a group of one or more of glycidyl ether type. The kit further comprises instructions which recite that the biopolymer part and bio-crosslinker are to be applied separately.

In one proposed embodiment of the fourth aspect the instructions further recite:
i) that the biopolymer part and bio-crosslinker part are applied onto either or both of two substrates to be glued such that when the two substrates are facing each other the two parts have a distance of less than 5 mm between the biopolymer part and bio-crosslinker part;
ii) that said two parts are to be pressed together; and
iii) that at least one of the two parts are applied either as a strand or by means of spraying, rolling, curtain coating, or through a unit comprising at least two hollow members, with a dedicated member for each part, or any combination of the aforementioned methods, applied in any sequence.

In one proposed embodiment of the fourth aspect of the present invention the instructions provided with the kit take into account the relationship between the application distance of the biopolymer and bio-crosslinker parts and their respective viscosities. In one instance, the instructions guide the user to apply the biopolymer part and the bio-crosslinker part with a distance of 0-5 mm apart. This specific distance is suitable when the viscosity of the biopolymer part, the bio-crosslinker part, or potentially both, falls within the range of from 50 to 1500 mPas. Such a distance ensures proper interaction between the parts, accommodating the flow characteristics of parts with this viscosity range.

Furthermore, in scenarios where the viscosity of the biopolymer and/or bio-crosslinker parts rises to span between 1500 and 3000 mPas, the instructions recommend a slightly narrower application distance of 0-3 mm apart. This distance is adjusted to accommodate the differing flow properties, ensuring the two parts interact optimally even at this altered viscosity level.

Lastly, for the kits where the parts viscosities reach between 3000 and 6000 mPas, the instructions guide users to apply the biopolymer and bio-crosslinker parts at an even closer range of 0-2 mm apart. Given the higher viscosity, this proximity promotes the required interaction for effective bonding between the parts.

A desired viscosity is achieved by adjusting the dry content of the biopolymer part, which can be increased or decreased. This adjustment can be effected by the addition of components such as additives, diluents, thickeners, among others.

For the bio-crosslinker part, a desired viscosity can be attained by the incorporation of diluents, thickeners, or a combination of one or more high-viscosity bio-crosslinkers and one or more low-viscosity bio-crosslinkers. The viscosity is preferably determined using a Brookfield LVT instrument, with Spindle 4 at a rotation speed of 60 rpm and a temperature of 25° C.

The proposed kit may be packages such that the biopolymer part and bio-crosslinker part are delivered in two separate containers. The container may be prefilled with a specific ratio, or they may comprise the same amount of said parts but include instruction regarding the mixing proportions. In one embodiment the instruction recite that the weight ratio of biopolymer part to bio-crosslinker part ranges from 100:5 to 10:100 wt %, preferably from 100:30 to 50:100 wt % and most preferred from 100:50 to 100:100 wt %. In another embodiment container are prefilled with a specific ratio selected from the aforementioned weight ratios.

In one embodiment of the fourth aspect the biopolymer part is selected from a group consisting of: tannin, lignin, starch and other carbohydrate, or a mixture thereof. Furthermore, the bio-crosslinker part may be selected from a group consisting of: one or more of glycidyl ether type, such as glycerol diglycidyl ether, glycerol glycidylether, polyglycerol diglycidyl ether, polyglycerol polyglycidyl ether, glycerol triglycidyl ether, trimethylolpropane diglycidyl ether, polyoxypropylene glycol diglycidylether, polyoxypropylene glycol triglycidyl ether, diglycidylether of cyclohexane dimethanol, sorbitol polyglycidyl ether, alkoxylated glycerol polyglycidyl ether, trimethylolpropane triglycidyl ether, resorcinol diglycidyl ether, isosorbide diglycidyl ether, pentaerythritol tetraglycidyl ether, ethylene glycol diglycidyl ether, polyethylene glycol diglycidyl ether having 2-9 ethylene glycol units, propylene glycol diglycidyl ether having 1-5 propylene glycol units, diglycidyl ether of terminal diol having a linear carbon chain of 3-6 carbon atoms, or mixtures thereof.

In one embodiment according to the fourth aspect of the present invention, the instructions recite a sequence in which the parts are applied. In one proposed sequence the biopolymer part is applied before the bio-crosslinker part, in another the bio-crosslinker is applied before the biopolymer part. Some beneficial sequence requires that parts are divided into portions and applied in a specific order. For example, according to one embodiment the instruction recite that a portion of the biopolymer part is to be applied before the bio-crosslinker part is applied and that another portion of the biopolymer part is applied after the bio-crosslinker part is applied. This has the beneficial effect of creating a layered structure. The initial layer of biopolymer ensures that there's an adequate matrix for the bio-crosslinker to interact with. Once the bio-crosslinker is applied and begins its crosslinking process, the subsequent application of the biopolymer can encapsulate the bio-crosslinker, potentially providing enhanced stability, controlled release, or a protective barrier against environmental factors, leading to a composite material with diverse properties.

According to another embodiment the instruction recite that a part of the bio-crosslinker part is to be applied before the biopolymer part is applied and another part of the bio-crosslinker part is applied after the biopolymer part is applied. This has the beneficial effect of ensuring that the substrate is initially primed with reactive sites from the bio-crosslinker. The biopolymer, when applied, can rapidly bind to these primed sites. The subsequent application of the bio-crosslinker on top can ensure that any exposed or unreacted portions of the biopolymer are further crosslinked, leading to a more thorough and homogeneous crosslinking process. This approach can provide a final product with increased cohesive strength and potentially faster curing times.

Preferred features of each aspect of the invention are as for each of the other aspects mutatis mutandis. The prior art document (s) mentioned herein are incorporated to the fullest extent permitted by law. The invention is further described in the following examples, with appended FIGURES, which do not limit the scope of the invention in any way.

In the above mentioned aspects of the present invention it is suggested that the biopolymer part and the bio-crosslinker part are applied separately but in close proximity to each other. Specifically, these two adhesive parts are dispensed such that the distance between the areas where they are applied is less than 5 mm. This ensures a fine spatial arrangement and promotes effective crosslinking when they come into contact or are subjected to pressure. Notably, the present invention is not restricted to the application of these parts to a single substrate. Thus, it is conceivable that the biopolymer part could be applied to one substrate and the bio-crosslinker part to another. Upon bringing the two substrates together, either through pressing or other methods, the proximity of the biopolymer and bio-crosslinker facilitates efficient bonding and adhesive action. This arrangement offers flexibility in application methods and expands the scope of potential substrates or materials to which this adhesive system can be applied.

Embodiments of the present invention are described as mentioned in more detail with the aid of examples of embodiments the only purpose of which is to illustrate the invention and are in no way intended to limit its extent.

### Examples

### Biopolymer Part of the Biopolymer Adhesive System for Separate Application

Ex 1: Biopolymer part in form of aqueous solution was prepared first by adding 92 g of water at ambient temp and 70 g of tannin (93%) to a 500 ml beaker and were stirred for 20 minutes. Then, 21 g of 45% sodium hydroxide solution was added to the dispersion. The mix was stirred for 30-50 minutes to make sure that the tannin was completely dissolved in the alkaline solution, then 14 g of wheat flour was adding and stirred 20-30 min, then 2 g of calcium carbonate was added and stirred 10 min, then 2 g of surface tension altering agent was added and stirred 5-10 min, The biopolymer part aqueous solution was filtered from possible lumps and stored at ambient temperature before using. Viscosity 900 mPas (viscosimeter Brookfield LVT, temperature 25° C., spindle, 60 rpm).
Ex2: Biopolymer part in form of aqueous solution was prepared first by adding 92 g of water at ambient temp and 28 g of tannin (93%) and 42 g of lignin (95%) to a 500 ml beaker and were stirred for 20 minutes. Then, 21 g of 45% sodium hydroxide solution was added to the dispersion. The mix was stirred for 30-50 minutes to make sure that the tannin and lignin were completely dissolved in the alkaline solution. The mix was cooled to ambient temperatures, then 14 g of wheat flour was adding and stirred 20-30 min, then 2 g of calcium carbonate was added and stirred 10 min, then 2 g of surface tension altering agent was added and stirred 5-10 min, the biopolymer part aqueous solution was filtered from possible lumps and stored at ambient before using. Viscosity 1000 mPas (viscosimeter Brookfield LVT, temperature 25° C., spindle, 60 rpm).
Ex 3: Biopolymer part in form of aqueous solution was prepared first by adding 94 g of water at ambient temp and 25 g of tannin (93%), 42 g of lignin (95%) and 3 g of starch (92%) to a 500 ml beaker and were stirred for 20 minutes. Then, 21 g of 45% sodium hydroxide solution was added to the dispersion. The mix was stirred for 30-50 minutes to make sure that the tannin+lignin+starch were completely dissolved in the alkaline solution. The mix was cooled to ambient temperatures, then 12 g of wheat flour was added and stirred 20-30 min, then 2 g of calcium carbonate was added and stirred 10 min, then 2 g of surface tension altering agent was added and stirred 5-10 min, the biopolymer part aqueous solution was filtered from possible lumps and stored at ambient temperature before using. Viscosity 1000 mPas (viscosimeter Brookfield LVT, temperature 25° C., spindle, 60 rpm).
Ex 4: Biopolymer part in form of aqueous solution was prepared first by adding 97 g of water at ambient temp and 56 g of lignin (95%) to a 500 ml beaker and were stirred for 20 minutes. Then, 29 g of 45% sodium hydroxide solution was added to the dispersion. The mix was stirred for 30-50 minutes to make sure that the lignin was completely dissolved in the alkaline solution. The mix was cooled to ambient temperatures, then 16 g of wheat flour was added and stirred 20-30 min, then 3 g of surface tension altering agent was added and stirred 5-10 min, the biopolymer part aqueous solution was filtered from possible lumps and stored at ambient temperature before using. Viscosity 1000 mPas (viscosimeter Brookfield LVT, temperature 25° C., spindle, 60 rpm).
Ex 5: Biopolymer part in form of aqueous solution was prepared first by adding 72 g of water and 25.4 g of propylene glycol at ambient temp and 28 g of tannin (93%) and 30 g of lignin (95%) to a 500 ml beaker and were stirred for 20 minutes. Then, 32 g of 45% sodium hydroxide solution was added to the dispersion. The mix was stirred for 30-50 minutes to make sure that the tannin+lignin was completely dissolved in the alkaline solution. The mix was cooled to ambient temperatures, then 3 g of starch was adding and stirred 10-15 min, then 9 g of urea was added and stirred 10 min, then 0.6 g of surface tension altering agent was added and stirred 5-10 min, the biopolymer part aqueous solution was filtered from possible lumps and stored at ambient temperature before use. Viscosity 700 mPas (viscosimeter Brookfield LVT, temperature 25° C., spindle, 60 rpm).
Ex 6: Biopolymer part in form of aqueous solution was prepared first by adding 75 g of water at ambient temp and 9 g of tannin (93%) and 63 g of lignin (95%) to a 500 ml beaker and were stirred for 20 minutes. Then 45 g of 45% sodium hydroxide solution was added to the dispersion. The mix was stirred for 30-50 minutes to make sure that the lignin and tannin was completely dissolved in the alkaline solution. The mix was cooled to ambient temperature, then 5 g of wheat flour was added and stirred 5 min, then 0,4 g of surface tension altering agent and 2 g of wax was added and stirred 5-10 min, the biopolymer part aqueous solution was filtered from possible lumps and stored at ambient temperature before using. Viscosity 1000 mPas measured with viscosimeter Brookfield LVT, temperature 25° C., spindle 4, 60 rpm.

### Bio-Crosslinker Part of the Biopolymer Adhesive System for Separate Application

Ex 1: The bio-crosslinker part in form of aqueous solution was prepared by mixing 99 g glycerol diglycidylether and 1 g surfactant (i.e. surface tension altering agent). Ethylan 1005 was the surfactant and it had been provided by Krahn Chemie. Viscosity 900 mPas (viscosimeter Brookfield LVT, temperature 25° C., spindle, 60 rpm).
Ex 2: The bio-crosslinker part in form of aqueous solution was prepared by mixing 99 g polyglycerol-polyglycidyl ether and 1 g surfactant. Ethylan 1005 was the surfactant and it had been provided by Krahn Chemie. Viscosity 1000 mPas (viscosimeter Brookfield LVT, temperature 25° C., spindle, 60 rpm).
Ex 3: The bio-crosslinker part in form of aqueous solution was prepared by mixing 50 g polyglycerol-polyglycidyl ether with 49 g diluent Styrene butadiene rubber, then added 1 g surfactant. Berol 360 was the surfactant and it had been provided by Krahn Chemie. Viscosity 400 mPas (viscosimeter Brookfield LVT, temperature 25° C., spindle, 60 rpm).
Ex 4: The bio-crosslinker part in form of aqueous solution was prepared by mixing 50 g polyglycerol-polyglycidyl ether with 50 g diluent polypropylene glycol. Viscosity 670 mPas (viscosimeter Brookfield LVT, temperature 25° C., spindle, 60 rpm).
Ex 5: The bio-crosslinker part in form of aqueous solution was prepared by mixing 30 g glycol/propylene carbonate with 30 g lignin. The mix was stirred for 30 min. Then, 40 g of polyglycerol polyglycidyl ether was added. The mix was stirred for 15 min.
Ex 6: The bio-crosslinker part in form of aqueous solution was prepared first by adding 36 g of water at ambient temp and then 8.5 g of lignin (95%) and 1,5 g of tannin (93%) to a 500 ml beaker and were stirred for 20 minutes. Then, 4 g of 45% sodium hydroxide solution was added to the dispersion. The mix was stirred for 30-50 minutes to make sure that the lignin+tannin was completely dissolved in the alkaline solution. The mix was cooled to ambient temperature. Then add and mix 50 g of bio-crosslinker Glycerol diglycidylether and stir 5 min, Viscosity 900 mPas (viscosimeter Brookfield LVT, temperature 25° C., spindle 4, 60 rpm).

The surface tension altering agents that were used in examples were thus:
Ethylan 1005: 2-propyl-heptanol-etoxilate
Berol 360: C10—alcohol-etoxilate
Polypropylene glycol
Sodium dodecylbenzenesulfonate (SDBS)

### Gluing and Testing According to EN-314

Gluing parameters: biopolymer part+bio-crosslinker part=235 g/m2, closed assembly time=10 min, pressing factor=60 sec/mm, wood veneer=3 mm spruce, construction=5 ply 20×20 cm, pressure=1.8 Mpa. Pressing temperature=130° C.
A—The biopolymer part in Ex1 and bio-crosslinker part in Ex1 was tested according to the standard testing method EN 314. Target amount of the biopolymer part was 168 g/m2 and target amount of bio-crosslinker part was 67 g/m2, were spread on one side separately (bio-crosslinker part first and the biopolymer part after and distance between them 0 mm) using a roller applicator. Hot pressing was performed at 130° C. with a pressure of 1.8 MPa. The total pressing time was 15 minutes for 15 mm thick construction (5 ply with 3 mm each). Tested according EN314 norm (immersion in water 23 C/24 h), see results in the table 1.
B—The biopolymer part in Ex2 and bio-crosslinker part in Ex2 was tested according to the standard testing method EN 314. Target amount of the biopolymer part was 168 g/m2 and target amount of bio-crosslinker part was 67 g/m2 were spread on one side separately (cross-linker part first and the biopolymer part after and distance between them 0 mm) using a roller applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
C—The biopolymer part in Ex2 and bio-crosslinker part in Ex3 was tested according to the standard testing method EN 314. Target amount of the biopolymer part was 147 g/m2 and target bio-crosslinker part amount was 88 g/m2 were spread on one side separately (bio-crosslinker part first and the biopolymer part after and distance between them 0 mm) using a roller applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
D—The biopolymer part in Ex3 and bio-crosslinker part in Ex3 was tested according to the standard testing method EN 314. Target amount of the biopolymer part was 147 g/m2 and target bio-crosslinker part amount was 88 g/m2 were spread on one side separately (bio-crosslinker part first and the biopolymer part after and distance between them 0 mm) using a roller applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
E—The biopolymer part in Ex4 and bio-crosslinker part in Ex4 was tested according to the standard testing method EN 314. Target amount of the biopolymer part was 157 g/m2 and target bio-crosslinker part amount was 78 g/m2 were spread on one side separately (bio-crosslinker part first and the biopolymer part after and distance between them 0 mm) using a roller applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
F—The biopolymer part in Ex4 and bio-crosslinker part in Ex5 was tested according to the standard testing method EN 314. Target amount of the biopolymer part was 117.5 g/m2 and target bio-crosslinker part amount was 117.5 g/m2 were spread on one side separately (bio-crosslinker part first and then the biopolymer part after and then the bio-crosslinker after and distance between them 0 mm) using a roller applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
G—The biopolymer part in Ex1 without bio-crosslinker part was tested according to the standard testing method EN 314. Target amount of the biopolymer part was 280 g/m2 were spread on one side using a roller applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
H—The biopolymer part in Ex2 was tested without bio-crosslinker part according to the standard testing method EN 314. Target amount of the biopolymer part was 280 g/m2 were spread on one side using a roller applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
I—The biopolymer part in Ex3 was tested without bio-crosslinker part according to the standard testing method EN 314. Target amount of the biopolymer part was 280 g/m2 were spread on one side using a roller applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
J—The biopolymer part in Ex4 was tested without bio-crosslinker part according to the standard testing method EN 314. Target amount of the biopolymer part was 280 g/m2 g/m2 were spread on one side using a roller applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
K—The biopolymer part in Ex6 and bio-crosslinker part in Ex6 was tested according to the standard testing method EN 314. Target amount of the biopolymer part was 168 g/m2 and target bio-crosslinker part amount was 67 g/m2 were spread on one side separately (bio-crosslinker part first and the bio-polymer part after and distance between them 0 mm) using a roller applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
L—The biopolymer part in Ex2 and bio-crosslinker part in Ex4 was tested according to the standard testing method EN 314. Target amount of the biopolymer part was 157 g/m2 and target bio-crosslinker part amount was 78 g/m2 were spread on one side separately (bio-crosslinker part first and the biopolymer part after and distance between them 2.3 mm) using a ribbon applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
M—The biopolymer part in Ex2 and bio-crosslinker part in Ex4 was tested according to the standard testing method EN 314. Target amount of the biopolymer part was 157 g/m2 and target bio-crosslinker part amount was 78 g/m2 were spread on one side separately (bio-crosslinker part first and the biopolymer part after and distance between them 4.6 mm) using a ribbon applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
N—The biopolymer part in Ex2 and bio-crosslinker part in Ex4 was tested according to the standard testing method EN 314. Target amount of the biopolymer part was 157 g/m2 and target bio-crosslinker part amount was 78 g/m2 were spread on one side separately (bio-crosslinker part first and the biopolymer part after and distance between them 6.6 mm) using a ribbon applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
O—The biopolymer part in Ex4 and bio-crosslinker part in Ex4 was tested according to the standard testing method EN 314. Target amount of the biopolymer part was 157 g/m2 and target bio-crosslinker part amount was 78 g/m2 were spread on one side separately (bio-crosslinker part first and the biopolymer part after and distance between them 2.3 mm) using a ribbon applicator. Hot pressing was performed at 130° C. with a pressure of 1.8 Mpa. The total pressing time was 15 minutes for 15 mm thick construction (5 ply with 3 mm each). Tested according EN314 norm (immersion in water 23 C/24 h), see results in the table 1.
P—The biopolymer part in Ex4 and bio-crosslinker part in Ex4 was tested according to the standard testing method EN 314. Target amount of the biopolymer part was 157 g/m2 and target bio-crosslinker part amount was 78 g/m2 were spread on one side separately (bio-crosslinker part first and the biopolymer part after and distance between them 6.6 mm) using a ribbon applicator. Hot pressing was performed at 13 C with a pressure of 1.8 Mpa. The total pressing time was 15 minutes for 15 mm thick construction (5 ply with 3 mm each). Tested according EN314 norm (immersion in water 23 C/24 h), see results in the table 1.

TABLE 1
Summary of results

| | | Ratio | | Distance | | | Wet strength | | |
|---|---|---|---|---|---|---|---|---|---|
| | Biopolymer | Mixing | | between | | | (immersion | | |
| | part/bio- | biopolymer/ | | Biopolymer | Dry | | in water | | |
| | crosslinker | bio- | | part and bio- | strength | Wood | 23 C./24 H) | Wood | |
| Gluing | part | crosslinker | Application | crosslinker | (N/mm2) | failure | (N/mm2) | failure | Result |
| A | Ex1/Ex1 | 100/40 | Separately | 0 mm | 1.4 | 70% | 0.75 | 45% | Pass |
| B | Ex2/Ex2 | 100/40 | Separately | 0 mm | 1.6 | 75% | 0.70 | 55% | Pass |
| C | Ex2/Ex3 | 100/60 | Separately | 0 mm | 2.0 | 75% | 0.9 | 50% | Pass |
| D | EX3/EX3 | 100/60 | Separately | 0 mm | 1.5 | 80% | 1.02 | 45% | Pass |
| E | Ex4/Ex4 | 100/50 | Separately | 0 mm | 1.6 | 75% | 1.05 | 47% | Pass |
| F | Ex4/Ex5 | 100/100 | Separately | 0 mm | 1.7 | 80% | 1.03 | 55% | Pass |
| G | Ex1/Ex1 | 100/0 | — | — | 0.2 | 0 | 0 | 0 | Not pass |
| H | Ex2/Ex2 | 100/0 | — | — | 0.1 | 5 | 0 | 0 | Not pass |
| I | Ex3/Ex3 | 100/0 | — | — | 0.23 | 0 | 0 | 0 | Not pass |
| J | Ex4/Ex4 | 100/0 | — | — | 0.24 | 0 | 0 | 0 | Not pass |
| K | Ex6/Ex6 | 100/40 | Separately | 0 mm | 1.3 | 75% | 0.93 | 60% | Pass |
| L | Ex2/Ex4 | 100/50 | Separately | 2.3 mm | 1.4 | 77% | 0.76 | 50% | Pass |
| M | Ex2/Ex4 | 100/50 | Separately | 4.5 mm | 1.5 | 75% | 0.81 | 48% | Pass |
| N | Ex2/Ex4 | 100/50 | Separately | 6.6 mm | 0.4 | 35% | 0.0 | 0.0 | Not pass |
| O | Ex4/W4 | 100/50 | Separately | 2.3 mm | 1.2 | 80% | 1.0 | 50% | Pass |
| P | Ex4/Ex 4 | 100/50 | Separately | 6.6 mm | 0.1 | 2% | 0 | 0 | Not pass |

| Requirement acc. EN314 | Requirement acc. EN314 |
|---|---|
| Strengh N/mm2 | Wood failure % |
| 0.2 < f < 0.4 | >80% |
| 0.4 < f < 0.6 | >60% |
| 0.6 < f < 1.0 | >40% |
| 1.0 | none |

Gluing and Testing of Internal Bonding Acc. To ASTM 1037
Gluing parameters: biopolymer part+bio-crosslinker part=12% dry adhesive for dry wood, pressing factor=11 sec/mm, board thickness 12 mm, pressing temperature=210° C., wood core layer+surface layer ratio 65/35.
1—The biopolymer part in Ex2 and bio-crosslinker part in Ex3 was tested according to the standard testing for internal bonding. Target amount of the biopolymer part was 7.5% (dry glue/dry wood) and target amount of bio-crosslinker part was 4.5% (dry bio-crosslinker component/dry wood). First the biopolymer part was sprayed on the wood and the bio-crosslinker part was sprayed after separately on the wood, then the wood+biopolymer part and bio-crosslinker part was mixed for 5 min in normal speed mixing machine, then the treated wood with the biopolymer adhesive system was transferred to a form and pressed to a board with thickness 12 mm at 210° C. and pressing time 132 sec. The board was cut and tested in an internal bonding machine acc. To the ASTM norm. See results in table 2.
2—The biopolymer part in Ex5 and bio-crosslinker part in Ex2 was tested according to the standard testing for internal bonding. Target amount of the biopolymer part was 8.5% (dry biopolymer/dry wood) and target amount of bio-crosslinker part was 3.5% (dry bio-crosslinker/dry wood). First the biopolymer part was sprayed on the wood and the bio-crosslinker part was sprayed separately on the wood after, then the wood+biopolymer part and bio-crosslinker part was mixed around for 5 min in normal speed mixing machine, then the treated wood with the biopolymer adhesive system was transferred to a form and pressed to a board with thickness 12 mm at 210° C. and pressing time 132 sec. The board was cut and tested in an internal bonding machine acc. To the ASTM norm. See results in table 2.
3—The biopolymer part in Ex2 was tested without bio-crosslinker part according to the standard testing for internal bonding. Target amount of the biopolymer part was 12% (dry biopolymer part/dry wood). The biopolymer part was sprayed on the wood, then the wood+biopolymer part was mixed around for 5 min in normal speed mixing machine, then the treated wood with the biopolymer part was transferred to a form and pressed to a board with thickness 12 mm at 210° C. and pressing time 132 sec. The board was cut and tested in an internal bonding machine acc. To the ASTM norm. See results in table 2.
4—The biopolymer part in Ex5 was tested without bio-crosslinker part according to the standard testing for internal bonding. Target amount of the biopolymer part was 12% (dry biopolymer component/dry wood). The biopolymer part was sprayed on the wood, then the wood+biopolymer part was mixed around for 5 min in normal speed mixing machine, then the treated wood with the biopolymer part was transferred to a form and pressed to a board with thickness 12 mm at 210° C. and pressing time 132 sec. The board was cut and tested in an internal bonding machine according to the ASTM norm. See results in table 2.

TABLE 2
Summary of results

| | | Ratio | | | |
|---|---|---|---|---|---|
| | Biopolymer | Biopolymer | | Internal | |
| | part/bio- | part/bio- | | bonding | Requirement |
| | crosslinker | crosslinker | Applica- | (IB) | Strengh IB |
| Gluing | part | part | tion | N/mm2 | N/mm2 |
| 1 | Ex2/Ex3 | 100/60 | Separately | 0.60 | >0.35 |
| 2 | Ex5/EX2 | 100/40 | Separately | 0.45 | >0.35 |
| 3 | EX2 | 100/0 | — | 0.1 | >0.35 |
| 4 | EX5 | 100/0 | — | 0.05 | >0.35 |

Various embodiments of the present invention have been described above but a person skilled in the art realises further minor alterations that would fall into the scope of the present invention. The breadth and scope of the present invention should not be limited by any of the above-described exemplary embodiments but should be defined only in accordance with the following claims and their equivalents. For example, any of the above-noted compositions or methods may be combined with other known methods. Other aspects, advantages- and modifications within the scope of the invention will be apparent to those skilled in the art to which the invention pertains.

1. A method of applying a biopolymer adhesive system, comprising applying in any order onto at least one substrate:
i) at least one biopolymer part comprising at least one biopolymer component in aqueous solution form, wherein said at least one biopolymer component is selected from a group consisting of: tannin, lignin, starch and other carbohydrate, and mixtures thereof;
ii) at least one bio-crosslinker part comprising at least one bio-crosslinker component in aqueous solution form, wherein said at least one bio-crosslinker component is selected from a group consisting of one or more of a glycidyl ether;
wherein a viscosity of the at least one biopolymer part, or the at least one bio-crosslinker part, or both is below 6,000 mPas, and
wherein the at least one biopolymer part and the at least one bio-crosslinker part are applied separately onto at least one substrate with a distance of less than 5 mm between the at least one biopolymer part and the at least one bio-crosslinker part, as a strand, or by spraying, or roller, or curtain or with at least two hollow members, one member for each part, or any combination thereof.

2. The method according to claim 1, wherein said at least one bio-crosslinker component is selected from a group consisting of: as glycerol diglycidyl ether, glycerol glycidylether, polyglycerol diglycidyl ether, polyglycerol polyglycidyl ether, glycerol triglycidyl ether, trimethylolpropane diglycidyl ether, polyoxypropylene glycol diglycidylether, polyoxypropylene glycol triglycidyl ether, diglycidylether of cyclohexane dimethanol, sorbitol polyglycidyl ether, alkoxylated glycerol polyglycidyl ether, trimethylolpropane triglycidyl ether, resorcinol diglycidyl ether, isosorbide diglycidyl ether, pentaerythritol tetraglycidyl ether, ethylene glycol diglycidyl ether, polyethylene glycol diglycidyl ether having 2-9 ethylene glycol units, propylene glycol diglycidyl ether having 1-5 propylene glycol units, diglycidyl ether of terminal diol having a linear carbon chain of 3-6 carbon atoms, and mixtures thereof.

3. The method according to claim 2, wherein said at least one bio-crosslinker component is glycerol diglycidylether, glycerol glycidylether, glycerol polyglycidylether, polyglycerol polyglycidyl ether, or a mixture thereof.

4. The method according to claim 1, wherein said at least one biopolymer component comprises lignin, and
wherein said lignin is selected from a group consisting of: Kraft lignin, lignosulfonate, organosolv lignin, soda lignin or lignin extracted from sugar cane bagasse, a lignin isolated from black liquor, and mixtures thereof, and
wherein, optionally, said lignin has been further purified and optionally modified by glyoxylation, etherification or esterification.

5. The method according to claim 4, wherein said lignin is Kraft lignin or lignin extracted from sugar cane bagasse.

6. The method according to claim 1, wherein said at least one biopolymer component comprises tannin, and
wherein said tannin is optionally modified.

7. The method according to claim 1, wherein said at least one biopolymer part, at least one bio-crosslinker part, or both further comprises a surface tension altering agent, and
wherein the surface tension altering agent is selected from a group consisting of: surfactant, non-ionic surfactants or tensides, polyisobutylene succinic anhydride (PIBSA) based surfactant, polypropylene glycol (PPG), paraffinic compounds, and combinations thereof.

8. The method according to claim 7, wherein said surface tension altering agent is a non-ionic surfactant, PIBSA-based surfactant, or a combination thereof.

9. The method according to claim 1, wherein a weight ratio of the at least one biopolymer part to the at least one bio-crosslinker part is in a range from 100:5 to 10:100 wt %.

10. A biopolymer adhesive system obtained by the method according to claim 1.

11. The method of claim 1, wherein the at least one substrate comprises engineered wood, gluelam, LVL, Japanese posts, duo/trio lamella, interior wood, finger jointing, or a wood based panel.

12. A kit comprising:
i) a biopolymer part in aqueous solution form comprising at least one biopolymer component selected from a group consisting of: tannin, lignin, starch and other carbohydrate, and mixtures thereof, ii) a bio-crosslinker part in aqueous solution form comprising at least one biopolymer component selected from a group consisting of: one or more of glycidyl ethers, and
instructions for said kit,
wherein either the biopolymer part, the bio-crosslinker part, or both parts have a viscosity between 50 mPas and 6,000 mPas, and
wherein said instructions recite that the biopolymer part and the bio-crosslinker part are applied separately onto at least one substrate.

13. The kit according to claim 12, wherein the instructions further recite that the biopolymer part and the bio-crosslinker part are applied onto either or both of two substrates to be glued together such that when the two substrates are facing each other the two parts have a distance of less than 5 mm between the biopolymer part and bio-crosslinker part, and
that said two substrates are to be pressed together, and
that at least one of the two parts are applied either as a strand, by spraying, rolling, curtain coating, with at least two hollow members, with a dedicated member for each part, or any combination of foregoing, applied in any sequence.

14. The kit according to claim 12, wherein the instructions further recite that the biopolymer part and the bio-crosslinker part be applied with a distance of 0-5 mm apart, and wherein the viscosity of the biopolymer part, the bio-crosslinker part, or both, is from 50 to 1,500 mPas;
or that the instructions recite that the biopolymer part and the bio-crosslinker part be applied with a distance of 0-3 mm apart and wherein the viscosity of the biopolymer part, the bio-crosslinker part, or both is from 1,500 to 3,000 mPas; or
that the instructions recite that the biopolymer part and the bio-crosslinker part be applied with a distance of 0-2 mm apart and wherein the viscosity of the biopolymer part, the bio-crosslinker part, or both is from 3,000 to 6,000 mPas.

15. The kit according to claim 12, wherein a weight ratio of biopolymer part to the bio-crosslinker part ranges from 100:5 to 10:100 wt %.

16. The kit according to claim 12, wherein the biopolymer part is hydrophilic and the bio-crosslinker part is hydrophobic.

17. The kit according to claim 12, wherein said bio-crosslinker component is selected from a group consisting of: glycerol diglycidyl ether, glycerol glycidylether, polyglycerol diglycidyl ether, polyglycerol polyglycidyl ether, glycerol triglycidyl ether, trimethylolpropane diglycidyl ether, polyoxypropylene glycol diglycidylether, polyoxypropylene glycol triglycidyl ether, diglycidylether of cyclohexane dimethanol, sorbitol polyglycidyl ether, alkoxylated glycerol polyglycidyl ether, trimethylolpropane triglycidyl ether, resorcinol diglycidyl ether, isosorbide diglycidyl ether, pentaerythritol tetraglycidyl ether, ethylene glycol diglycidyl ether, polyethylene glycol diglycidyl ether having 2-9 ethylene glycol units, propylene glycol diglycidyl ether having 1-5 propylene glycol units, diglycidyl ether of terminal diol having a linear carbon chain of 3-6 carbon atoms, and mixtures thereof.

18. The kit according to claim 1, wherein said bio-crosslinker component is glycerol diglycidylether, glycerol glycidylether, glycerol polyglycidylether, polyglycerol polyglycidyl ether, or a mixture thereof.

19. (canceled)
